(19) United States
(12) Patent Application Publication
(10) Pub. No.: US 2005/0071771 A1
(43) Pub. Date: Mar. 31, 2005

(54) Menu displaying method and communication apparatus

(75) Inventors: Kazuyuki Nagasawa, Tokyo (JP); Kana Segawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/808,418

(22) Filed: Mar. 25, 2004

(30) Foreign Application Priority Data
Sep. 30, 2003 (JP) 2003-342565

(51) Int. Cl. G06F 3/00; G09G 5/00

(52) U.S. Cl. 715/765; 715/747; 715/744; 715/866; 715/745; 715/788; 715/746; 715/867; 345/619

(57) ABSTRACT

A communication apparatus, for instance a cellular phone, has menu, a memory for storing a picture and a display for displaying alphanumeric and a picture. If a user selects the picture stored in the memory, the selected picture is displayed on the display as wallpaper. When the picture is set as wallpaper and menu comprised of icons is displayed by operation, the icons are displayed in the form of a function name and outline.

### RELATED APPLICATION INFORMATION

This application is based upon and claims the benefit of priority from the prior Japanese Patent Application No.2003-342565 filed on Sep. 30, 2003;
the entire contents of which are incorporated herein by reference.

### FIELD OF THE INVENTION

The present invention relates to a communication apparatus capable of displaying menu, especially displaying icons as menu, and menu displaying method used in a communication apparatus.

### DESCRIPTION OF THE BACKGROUND

Communication apparatuses, for example, cellular phones, have a display capable of displaying multiple icons with symbol images. Each icon indicates a function to be selected by a user. The user manipulates operation keys and selects one icon for starting an application and so on.

For instance, Japanese Patent Disclosure (Kokai) No.2002-229705 discloses an apparatus for displaying icons that may be preset or customized by a user's operation. This document also discloses that the user can replace icons with a picture. Then, the picture is divided into multiple pieces and each piece is assigned to each icon.

In the apparatus mentioned above, however, because the picture is divided into multiple pieces and each piece is assigned to each icon, a cleft exists between pieces of the picture. Therefore, the visibility of the picture is spoiled. Also, dividing a picture is a heavy process for a processor. Further, the capacity for storing the pieces of the picture in addition to storing an original picture is needed.

There is also the technology that is capable of displaying the selectable icon bigger than other icons to indicate that the icon is in selectable state.

### SUMMARY OF THE INVENTION

Accordingly, an advantage of an aspect of the present invention is to provide an apparatus and method which can display icons with picture keeping the visibility.

To achieve the above advantage, one aspect of the present invention is to provide a communication apparatus that comprises a display configured to display alphanumeric and a picture, a key input unit with keys configured to input alphanumeric and selection information, a memory configured to store a picture, and a display controller configured to display menu which comprises the first icon, and to change the first icon to the second icon when the picture is displayed as wallpaper.

### BRIEF DESCRIPTION OF THE DRAWINGS

FIG. 1 is a block diagram illustrating an exemplary configuration of a radio communication apparatus according to an embodiment of the present invention.

FIG. 2 is a flowchart showing an exemplary process for customizing menu.

FIG. 3A shows an example of a preset menu which comprises nine icons.

FIG. 3B shows an example of a menu list.

FIG. 3C shows an example of wallpapers to be selected by a user.

FIG. 4A shows an example of menu with wallpaper.

FIG. 4B shows an example of switched icons.

FIG. 4C shows an example of assigning a picture to an icon.

FIG. 4D shows an example of an enlarged icon.

FIG. 5A shows an example of the non-selectable state of an icon made of geometrical patterns and a function name.

FIG. 5B shows an example of the selectable state of an icon made of geometrical patterns and a function name.

### DETAILED DESCRIPTION OF THE EMBODIMENTS

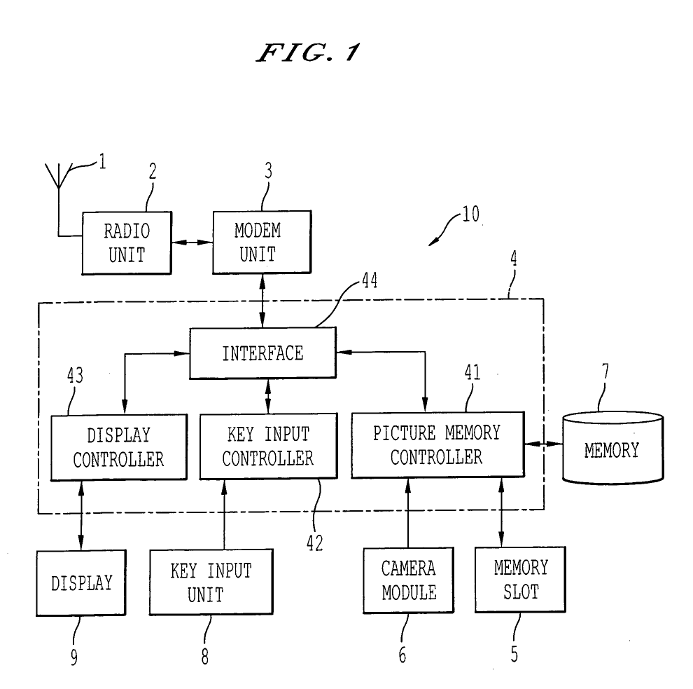

An embodiment in accordance with the present invention will be explained with reference to FIGS. 1 to 4.

FIG. 1 shows a configuration of a radio communication apparatus according to an illustrative embodiment of the invention.

A radio communication apparatus 10 shown in FIG. 1 comprises a radio unit 2 connected to an antenna 1, a modem unit 3, a controller 4, a memory slot 5, a camera module 6, a picture memory 7, a key input unit 8, and a display 9.

The controller 4 comprises a picture memory controller 41, a key input controller 42, a display controller 43, and interface 44 which interfaces the modem unit 3, the picture memory controller 41, the key input controller 42, and display controller 43.

The picture memory controller 41 receives picture information from the camera module 6 or an external memory, such as an FD memory and an IC memory card, inserted in the memory slot 5 and stores the picture information in the picture memory 7. The picture information may be downloaded from a server connected to a network (not shown). The picture information from the server is received by the antenna 1 and demodulated at the modem unit 3. The demodulated picture information is controlled by the controller 4 and stored in the picture memory 7.

The key input unit 8 comprises some keys for inputting a character and operation. One or more of the keys can be used for inputting a telephone number for making a call. One or more of the keys can be used for displaying a menu screen.

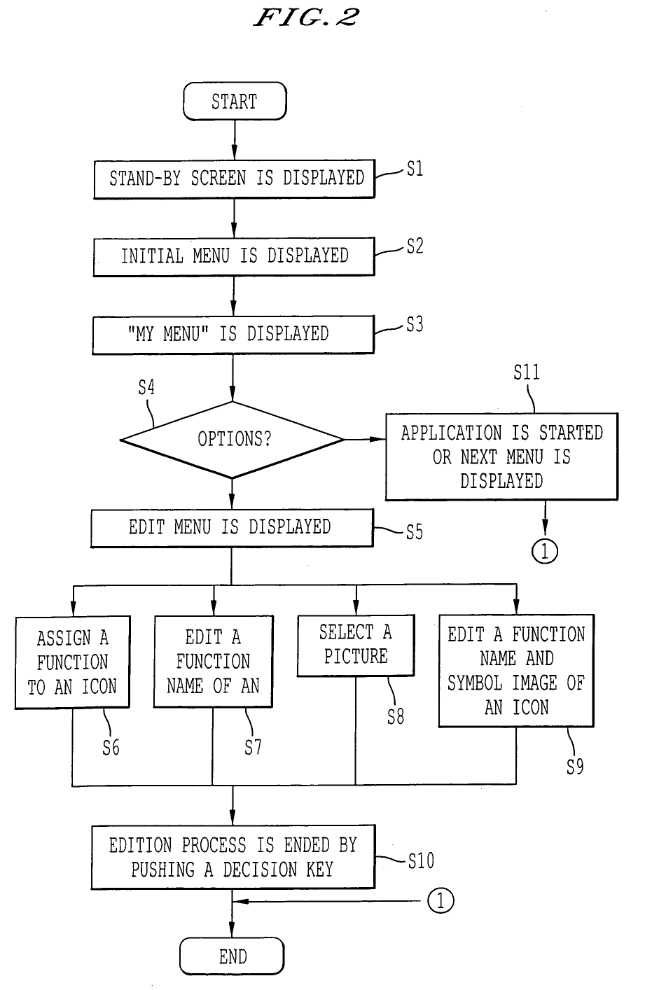

Next, operation of the radio communication apparatus 10 having the above configuration will be described. FIG. 2 is a flowchart showing an exemplary process for customizing a menu.

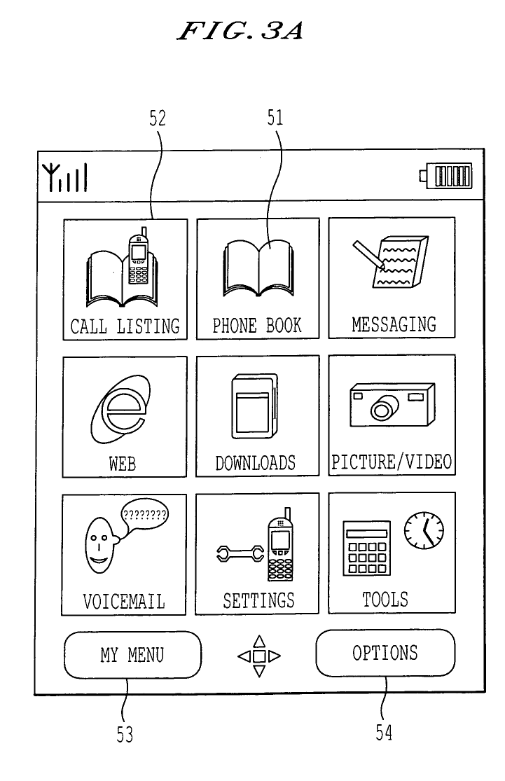

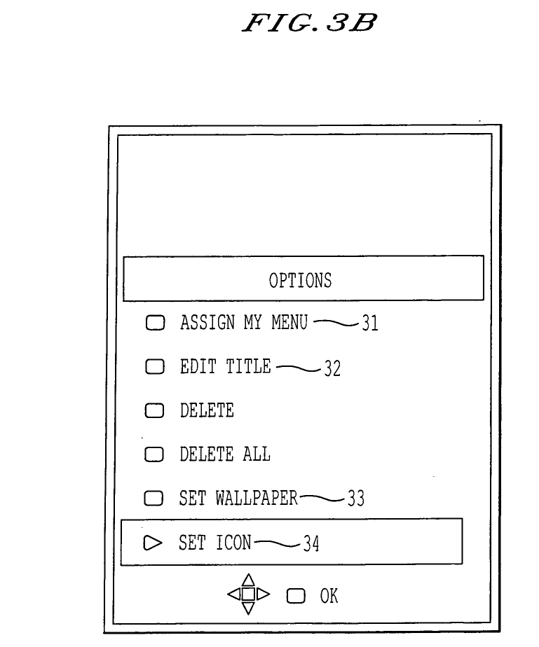

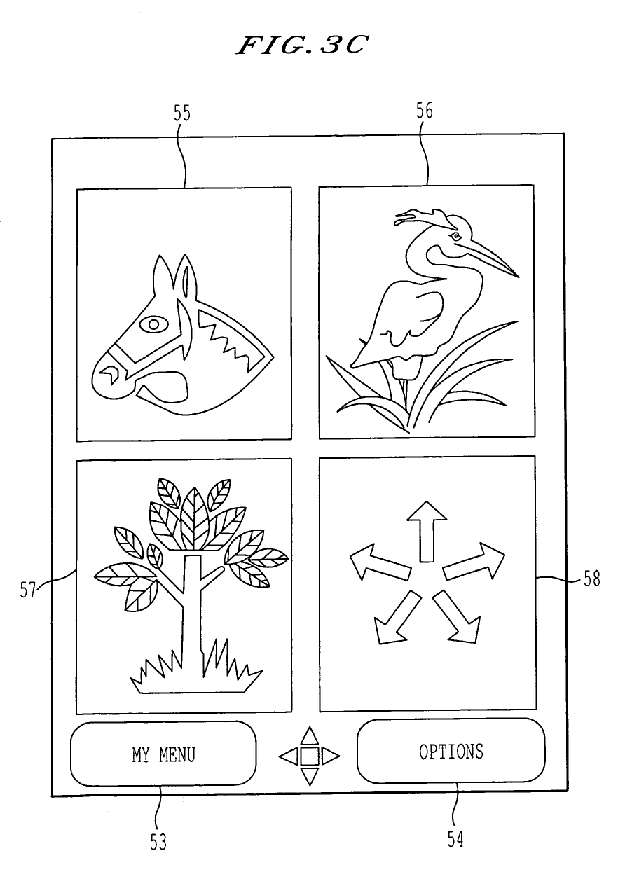

At first, when the power of the radio communication apparatus 10 is turned on by pushing a power button (not shown), stand-by screen having the current time, power information, and radio information (RSSI) is displayed on the display 9 (step S1). In this state, if a menu key of the key input unit 8 is pushed, an initial menu is displayed (Step S2). FIG. 3A shows this state, where nine icons and guidance information are displayed on the display 9. The guidance information is assigned to a specific key of the key input unit 8. Preferably, the specific keys are located close to the corresponding guidance information.

The specific key may be called soft key.

An icon 51 of FIG. 3A is one of the nine icons and is made of a function name and a symbol image. Other icons are also made of a function name and a symbol image. Cursor 52 of FIG. 3A indicates that an icon is selectable and moves among icons under the operation of direction key (not shown) of the key input unit 8.

FIG. 3A further shows two guidance information and each of the two guidance information indicates a function assigned to the specific key of the key input unit 8. In this example, “My Menu 53” and “Options 54” are expressed as guidance information. My Menu 53 means customized menu and a customized menu (hereinafter “my menu”) is displayed when the specific key corresponding to My Menu 53 is pushed. Options 53 means edit menu and an edit menu is displayed when the specific key corresponding to Option 53 is pushed.

FIG. 3B shows an example of the edit menu. The edit menu has some edit items and, for example, six edit items are displayed on the display 9.

When the initial menu shown in FIG. 3A is displayed and the specific key corresponding to My Menu 53 is pushed, my menu, which is customized by a user, is displayed on the display 9 (Step S3). The my menu is also has nine icons in this example and each icon, which indicates a specific function, is chosen by a user arbitrarily. Moreover, when the my menu is displayed, “Menu” is displayed as guidance information instead of “My Menu”. The menu displayed on the display 9 indicates that the initial menu will be displayed by pushing the specific key corresponding to the guidance information.

When My Menu is displayed and the specific key corresponding to Options 54 is pushed (Step S4), the edit menu of FIG. 3B is displayed in display 9 (Step S5).

The edit menu has at least four edit items, “Assign My Menu31”, “Edit Title 32”, “Set Wallpaper 33”, and “Set Icon 34” as shown in FIG. 3B.

When the edit menu is displayed and Assign My Menu 31 is selected by the operation using key input unit 8 (Step S6), function list (not shown) is displayed and user can edit which function is assigned to one icon on My Menu. The user ends editing by pushing a decision key of the key input unit 8 after the completion of the assignment (Step S10).

When Edit title 32 is selected by the operation using key input unit 8 (Step S7), the user can edit the name of each icon. The user selects the icon, which is the subject for editing, and inputs a new name using the key input unit 8. The user ends editing the name of the icon by pushing decision key (Step S10).

When Set Wallpaper 33 is selected by the operation using key input unit 8 (Step S8), the user can select a picture displayed as wallpaper. By selecting the Set Wallpaper 33, four pictures 55, 56, 57, and 58 are displayed on display 9 as shown in FIG. 3C. The user moves a cursor and sets the cursor on the desired picture to be displayed. If the user selects the desired picture or stops the selection, this process is ended by pushing the decision key (Step S10).

Besides the pictures stored beforehand in the picture memory 7, the pictures read from external memory or captured by the camera 6 can be also used as wallpaper.

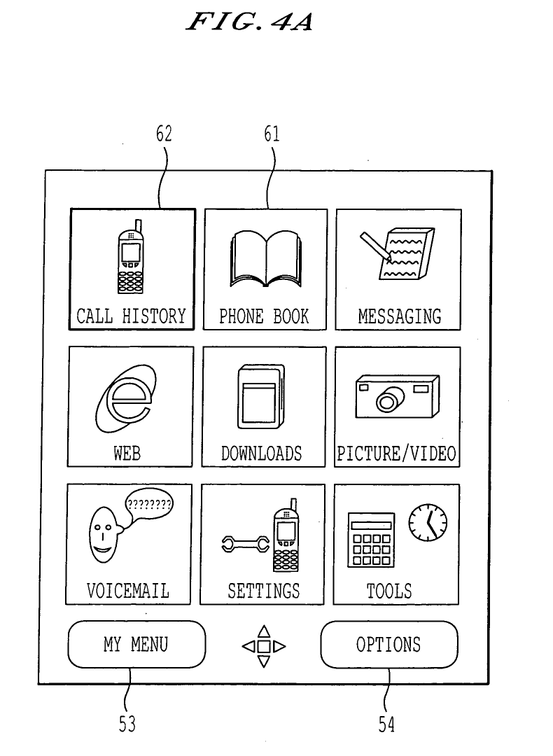

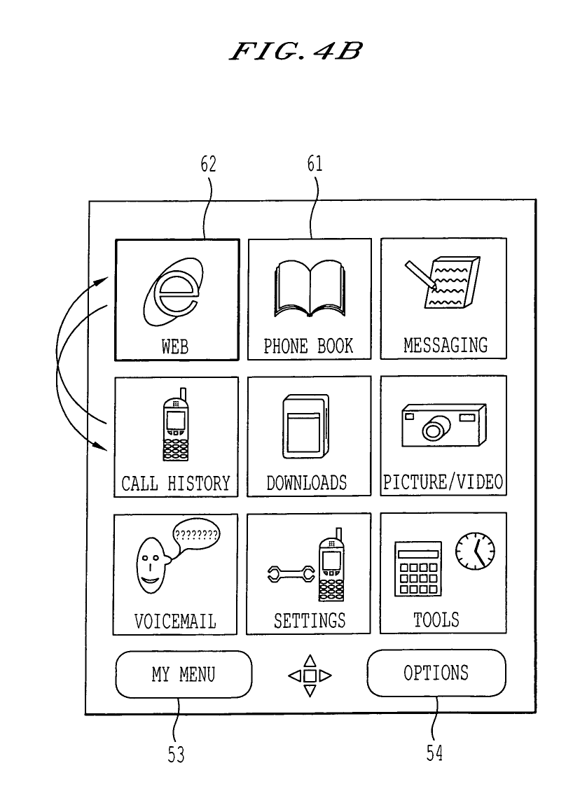

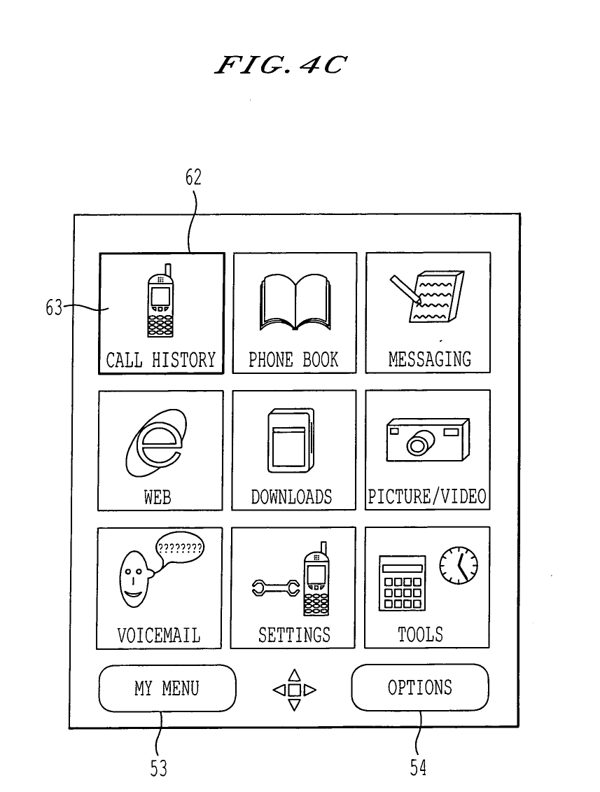

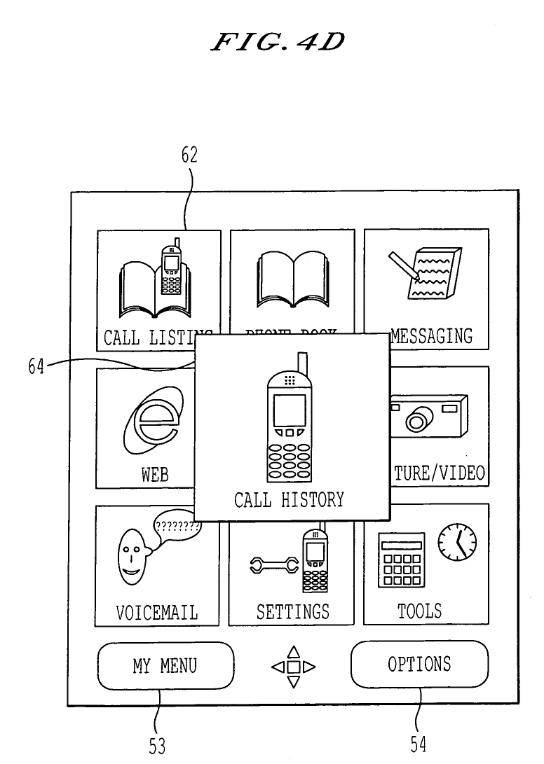

If the picture 58 is selected and decision key is pushed, the selected picture is displayed as wallpaper in the display 9. The selected picture will display not only stand-by screen but also the My Menu as shown in FIG. 4A.

In FIG. 4A, icon 61, which is one of nine icons, comprises a name of a function and outline. Other icons comprise the same.

The feature of displaying menu with the wallpaper is that the icons comprise the function name and outline; thus, the entire picture is displayed in the display 9 without losing visibility.

When Set Icon 34 is selected (Step S9), the user can edit the name and the symbol image of the icon 61 displayed in the display 9. As several thumbnail formed pictures or a list of the names of pictures are displayed in the display 9, user can select the desired pictures and change the symbol images of the icons. For example, the symbol image of the icon 61 can be changed to different symbol image by moving cursor 62 on icon 62 and pushing the specific key corresponding to guidance 53 or set key (not shown).

When the My Menu is displayed and the selection is executed other than the Options 54, an application is started or the next menu is displayed in display 9 (Step S11).

Also, icons' display locations can be switched. An example is shown in FIG. 4B. The operation can be improved by locating the most used icon at where the cursor 62 is displayed.

As shown in FIG. 4C, the specific icon can be indicated by a picture even when the menu with the wallpaper is displayed. Also, as shown in FIG. 4C, the selectable icon can by displayed in bigger size than other icons.

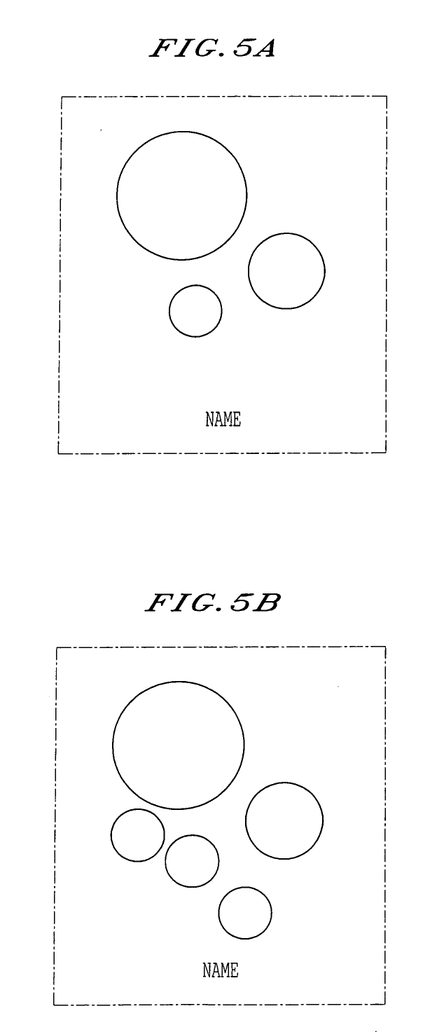

In the above-mentioned example, the visibility of the wallpaper is kept by composing the icons with the name and the outline. Same effect can be obtained by comprising the icons with geometrical patterns and name as shown in FIG. 5.

FIG. 5 shows an example of the icon comprising the geometrical patterns and a function name. In this example, there are several circles. FIG. 5A shows the state when the icon is not selectable and FIG. 5B shows the state when the icon is selectable. Thus, the differentiation of selectable icon and non-selectable icon is made by the change of geometrical patterns.

The geometrical patterns is not limited to circle but can use triangles, squares, and hearts.

In FIG. 5, the geometrical patterns and names are outlined by a dashed line. That is only to make it easy to see the composition of the icon. The dashed line is actually not displayed in the display 9.

As explained above, according to the embodiment of the invention, the utility and visibility of wallpaper can be maintained, and at the same time, the effectiveness of operation is improved by making icons transparent or enlarging icons.

1. Menu displaying method, comprising:
displaying first icon made of symbol image;
selecting a picture to be displayed as wallpaper;
changing the first icon to second icon made of a function name and outline;
displaying the second icon with the selected picture;

2. The menu displaying method according to claim 1, further comprising capturing picture from camera to be used as wallpaper.

3. The menu displaying method according to claim 1, further comprising storing a function name and a geometrical pattern, and changing the first icon to third icon made of a function name and a geometrical pattern.

4. The menu displaying method according to claim 1, further comprising storing a function name, first geometrical pattern and second geometrical pattern, and changing the first icon to first geometrical pattern when the icon is in non-selectable state.

5. The menu displaying method according to claim 4, further changing first icon to second geometrical pattern when the icon is in selectable state.

6. A communication apparatus, comprising:
a display configured to display alphanumeric and a picture;
a key input unit with keys configured to input alphanumeric and selection information;
a memory configured to store a picture; and
a display controller configured to display menu which comprises the first icon, and to change the first icon to the second icon when the picture is displayed as wallpaper.

7. The communication apparatus according to claim 6, further comprising a camera module for capturing a picture.

8. The communication apparatus according to claim 6, wherein the memory further stores a function name and a geometrical pattern, and the display controller changes the first icon to the third icon.

9. The communication apparatus according to claim 6, wherein the memory further stores a function name, first geometrical pattern and second geometrical pattern, and the display controller changes the first icon to the icon made of a function name and first geometrical pattern when the icon is in non-selectable state.

10. The communication apparatus according to claim 9, wherein the memory controller further changes first icon to the icon made of a function name and second geometrical pattern when the icon is in selectable state.

11. A communication apparatus, comprising:
a key input unit with keys configured to input alphanumeric and selection information;
a camera module configured to capture a picture;
a display configured to display a symbol image indicating an icon, alphanumeric, a picture, and guidance information corresponding to a specific key of the key input unit;
a memory configured to store a picture, a name of an icon and a geometrical pattern;
a display controller configured to control the display and the display menu comprised of icons.

12. A communication apparatus according to claim 11, wherein the display controller changes the first icon to the second icon when the picture is selected as wallpaper.

13. The communication apparatus according to claim 11, wherein the display controller changes the first icon to the third icon when the picture is selected as wallpaper.
